(19) United States
(12) Patent Application Publication
(10) Pub. No.: US 2010/0127150 A1
(43) Pub. Date: May 27, 2010

(54) Outboard Motor Mount

(76) Inventor: Luke Andrew Stuart Wakeham, Townsville (AU)

Correspondence Address: Luke Andrew Stuart Wakeham, 18 Dollview Avenue Rasmussen, Townsville, 4815, AU

(21) Appl. No.: 12/576,265

(22) Filed: Oct. 9, 2009

(30) Foreign Application Priority Data
Nov. 26, 2008 (AU) 2008 900 377

(51) Int. Cl. F16M 7/00

(52) U.S. Cl. 248/642

(57) ABSTRACT

The object of this invention is to alter speed and handling characteristics of an outboard motor boat. This Improved Outboard Motor Mount achieves this with the ability to adjust the distance between the outboard motor and the stern of the boat. Consequently, this movement uses the weight of the outboard motor as leverage to adjust the centre of gravity of the vessel to suit water conditions. Setting the outboard motor close to the stern of the boat will make the bow of the boat more difficult to lift, thus improving its handling performance in rough water. Setting the outboard away from the stern of the boat will make the bow of the boat easy to lift, improving boat speed. This Improved Outboard Motor Mount allows the consumer to optimize their outboard motor boats performance in a variety of water conditions.

### FIELD OF THE INVENTION

This invention relates to outboard motor mounts for boats. More particularly, the invention relates to a maneuverable mount for outboard motors to be fitted to the transom of a boat.

### BACKGROUND ART

Typically, outboard motors on water craft, such as a boat, are mounted onto a transom of the boat or an external transom bracket. It is known that placing the propeller of the motor at different distances and/or angles from the boat provides different handling, acceleration, and speed characteristics.

The motor can be mounted rearward of the transom which provides some advantages. For instance, having the significant weight of the engine further back can assist in lifting the bow of the boat. This minimises the surface area of the boat on the water, maximising speed.

Fuel efficiency is also improved as at a cruising speed a boat with less surface area needs less power to push it through the water. However, there are also negative side effects. Because the bow of the boat is more easily lifted, the boat will tip back when crossing big waves or rough water. It is therefore optimum to have the motor close to the transom when operating in rough water and further from the transom when operating in calm water.

It is known to manually reposition motors on boat transoms before starting a journey to accommodate changing operating conditions. However, the mounting bracket provided with boat motors typically has a very small range of adjustments available and furthermore, boat motors are usually heavy making it difficult to manually change the motor's position.

It is an object of the present invention to provide a maneuverable mount for outboard motors, or to at least provide consumers with a useful or commercial choice.

### SUMMARY OF THE INVENTION

According to a first aspect of the present invention, there is provided a maneuverable motor mount for a boat motor comprising:

a least one support structure having a portion extending substantially perpendicular to the transom of a boat;

a mounting plate that is substantially perpendicular to the support structure wherein the boat motor is bolted on to the mounting plate; and

a movement means to move a portion of the mounting plate along the support structure.

The performance of the boat is generally enhanced by the maneuverable motor mount adjusting the distance from the transom and thereby permitting the centre of gravity of the boat backwards, changing the leverage of the front of the boat. By moving the motor further back, the centre of gravity is also moved back, making the nose of the boat lighter and easier to lift. If the nose is lighter or easier to lift, the boat can achieve the minimum surface area with less of an angle against the water and consequently with less resistance and better high speed performance.

The maneuverable motor mount may further comprise a pivot assembly that engages with the support structure (and is typically attached thereto) to allow the support structure to be placed at an adjustable angle relative to waterline and the transom of the boat. Preferably the pivot assembly further comprises at least two separate plates that are hinged along one edge, normally an upper edge. The pivot assembly may be lockable at a desired angle to keep the support structure, and hence the boat motor, at the desired angle relative to the transom and waterline.

Alternatively, the at least one support structure may be attached directly to the boat, preferably the transom.

The mounting plate may be associated with one or more perpendicular extension plates that fit adjacent the at least one support structure. Furthermore, the perpendicular extensions may be provided with guide means to guide the movement of the mounting plate and preferably restrict the movement of the mounting plate beyond predetermined limits.

Preferably, the mounting plate can be moved relative to the support structure, with the boat motor attached, in a direction that is longitudinal to the boat axis. However, no limitation is meant thereby and the mounting plate may also be moved in any direction including horizontal, vertical, or at an angle.

Preferably, the maneuverable motor mount further comprises a locking or securing means to hold the mounting plate at a particular location on the support means. Even more preferably the locking or securing means comprises at least one bolt that can be bolted into at least one hole on both the mounting plate and the support structure.

In a preferred embodiment the support structure includes a face plate preferably extending substantially parallel to the transom of the boat, with two spaced apart support plates extending perpendicularly to the transom of the boat. Each perpendicular extension preferably has paired sets of locking openings. In the preferred embodiment, the locking openings are holes through the plates but it is anticipated that alternatives such as matching depressions formed in the plates can also be used.

Each of the support plates will typically be provided with a guide opening in addition to the locking openings. The guide openings will typically be an opening through the support plate but it is anticipated that alternatives such as matching depressions formed in the plates may be used. The guide openings will typically receive guide means provided on the extension plates of the mounting plate in order to guide and preferably support the mounting plate relative to the support.

The perpendicular extension plates will typically be received between the support plates with the motor received between the perpendicular extension plates. Preferably, the support plates extend further rearward than the perpendicular extension plates.

There will preferably be an upper and a lower set of locking openings on each support plate with an elongate guide opening adjacent each set of locking openings.

The mounting plate preferably has corresponding perpendicular extensions, each having two holes that match the paired sets of holes on the support plates, each matched hole preferably receiving a bolt to temporarily lock the mounting plate at a fixed position with respect to the support structure. The bolt may be any suitable size, but is preferably a half inch bolt.

The movement means may be a guide rail and a person applying force, or alternatively may be a powered means. If the movement means is powered, it is preferably affixed to at least the mounting plate and a portion of the transom of the boat. Alternatively, the movement means may be affixed to at least the mounting plate and a portion of the support structure.

Preferably, the movement means comprises an actuator such as one or more hydraulic cylinders, wherein a hydraulic cylinder is affixed to at least a portion of the transom and the piston is affixed to the mounting plate. When the hydraulic cylinder is extended the mounting plate is preferably at least moved along the support structure further away from the transom of the boat. When the hydraulic cylinder is retracted the mounting plate is preferably moved at least along the support structure towards the transom of the boat. The use of a hydraulic cylinder is used by way of example only and any other movement means, such as a pneumatic arrangement, or a rack and pinion system, could also be used.

In this arrangement the hydraulic cylinder can be used to manoeuvre the mounting plate with respect to the boat and subsequently move the boat motor, closer or further away from the rear of the boat. This enables an operator to select the desired distance from the transom that they would like the boat motor to operate at, and move it there with relative ease. The motor can then be temporarily locked in position,

The hydraulic cylinder may be used as an alternative locking means to the locking openings provided in the perpendicular extension plates.

Preferably, the mounting plate can be moved at least 20 cm away from the transom of the boat. Even more preferably the mounting plate can be moved at least 30 cm away from the transom of the boat dependant upon the length of the boat wherein the typical limits for a 30′ boat would be an adjustment of up to 60 cm.

The support structure may be recessed into the transom. This preferably enables the mounting plate to be moved to a location that is substantially flush with the transom of the boat.

Accordingly, the performance of the boat motor is generally enhanced by the maneuverable motor mount as the motor can be easily mounted away from the transom of the boat where the propeller of the motor can operate in quieter water. This occurs because the centre of gravity of the boat moves according to the position of the motor and the angle of the transom to the water and the angle of the motor to the waterline.

According to a second aspect of the invention there is provided a method of moving a boat motor with respect to a boat transom comprising the steps of:

ensuring a mounting plate is unlocked with respect to at least one support structure having at least one extension extending perpendicular to the boat transom;

moving the mounting plate along the perpendicular extensions of the support structure with a movement means to a desired location;

and securing the mounting plate at the desired location on the perpendicular extension of the support structure.

Preferably, the method of moving a boat motor with respect to a boat transom further comprises the step of mounting the boat motor to the mounting plate if it is not already fitted.

In order that the invention may be more readily understood and put into practice, one or more embodiments thereof will now be described, by way of example only, with reference to the accompanying drawings.

According to a broad aspect of the present invention, there is provided a maneuverable motor mount for a boat motor comprising:

a mounting plate adapted to attach a boat motor;

a support structure attached to a rear portion of the boat and mounting the mounting plate; and

a movement means to move at least a portion of the mounting plate relative to the support structure to adjust the separation distance of the boat motor from the rear of the boat.

The separation distance is preferably the distance between the mounting of the boat motor and the transom of the boat.

### BRIEF DESCRIPTION OF THE DRAWINGS

FIG. 1 is an exploded side view of an embodiment of the maneuverable motor mount showing the mount with respect to a boat and an outboard motor.

FIG. 2 is a close-up of the maneuverable motor mount as shown in FIG. 1.

FIG. 3 is a side view of the maneuverable motor mount showing the mount with respect to a boat and an outboard motor.

FIG. 4 is a close-up of the maneuverable motor mount as shown in FIG. 3.

FIG. 5 is an exploded perspective view of the maneuverable motor mount from the side.

FIG. 6 is an exploded perspective view of the maneuverable motor mount from the top and side.

FIG. 7 is an exploded perspective view of the maneuverable motor mount from the back and side.

FIG. 8 is a perspective view of the maneuverable motor mount from the front and side.

FIG. 9 is a perspective view of the maneuverable motor mount from the side.

FIG. 10 is a perspective view of the maneuverable motor mount from the top.

### DESCRIPTION OF PREFERRED EMBODIMENTS

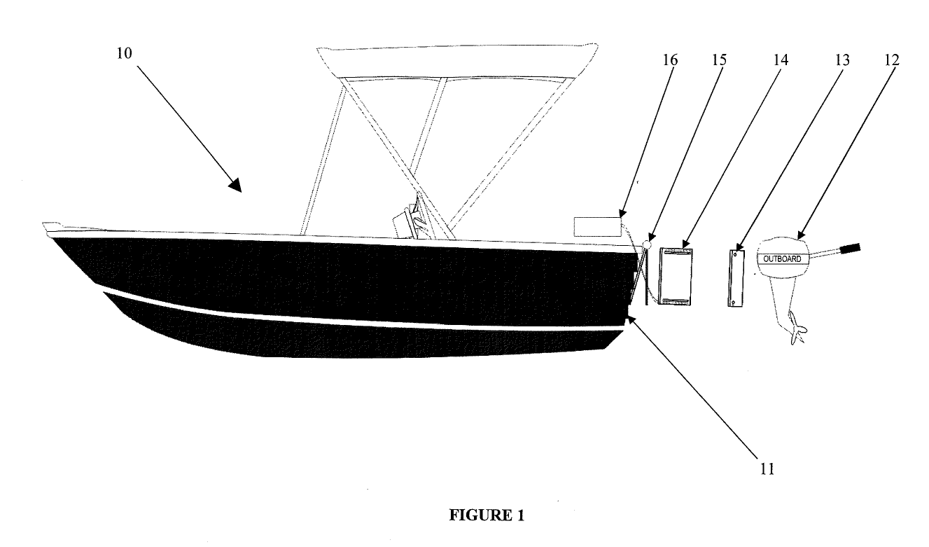

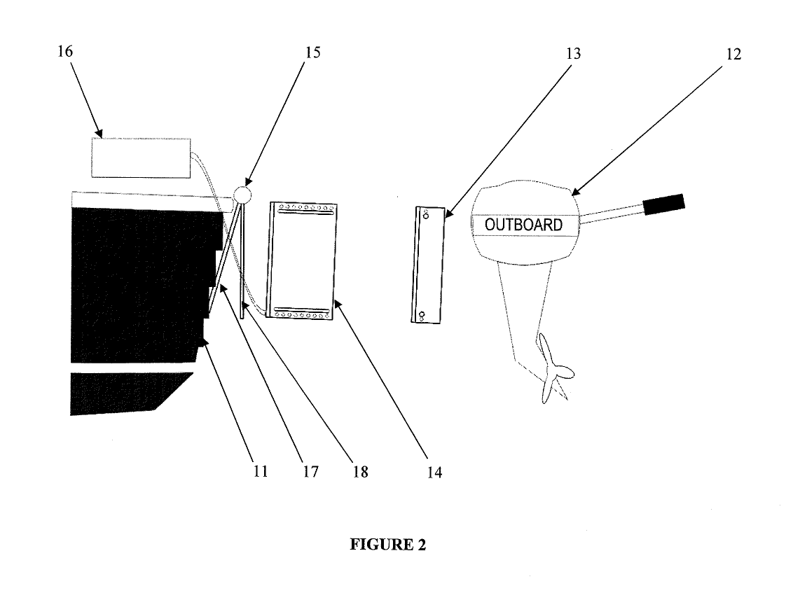

FIG. 1 illustrates a boat 10 having a transom 11 and an outboard motor 12. The outboard motor 12 would normally receive the transom 11 of the boat 10 into clamps (not shown). In an embodiment of the present invention, the outboard motor 12 instead clamps onto a mounting plate 13 which is received by a support structure 14. The support structure 14 is subsequently affixed to a pivot plate 15 that is affixed to the transom 11 of the boat 10. These components can be seen in more detail in FIG. 2.

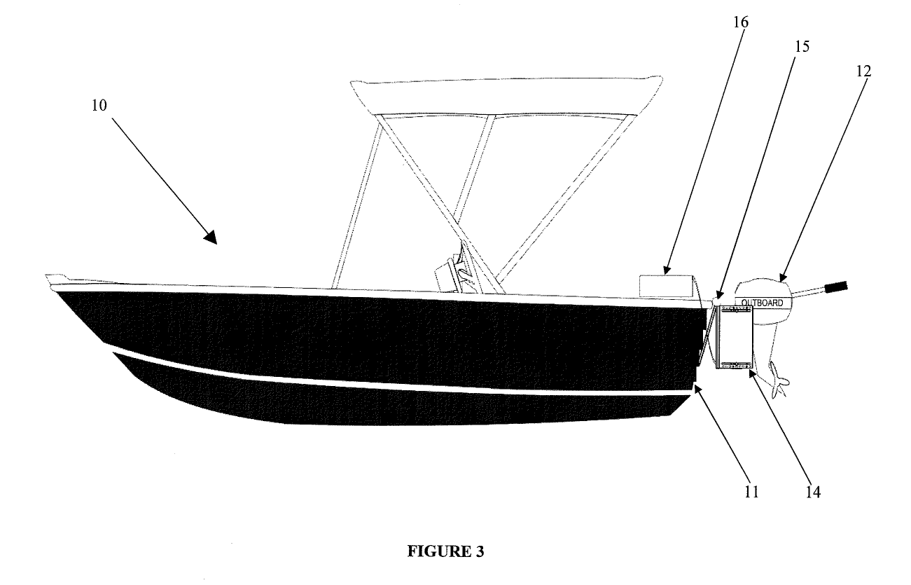

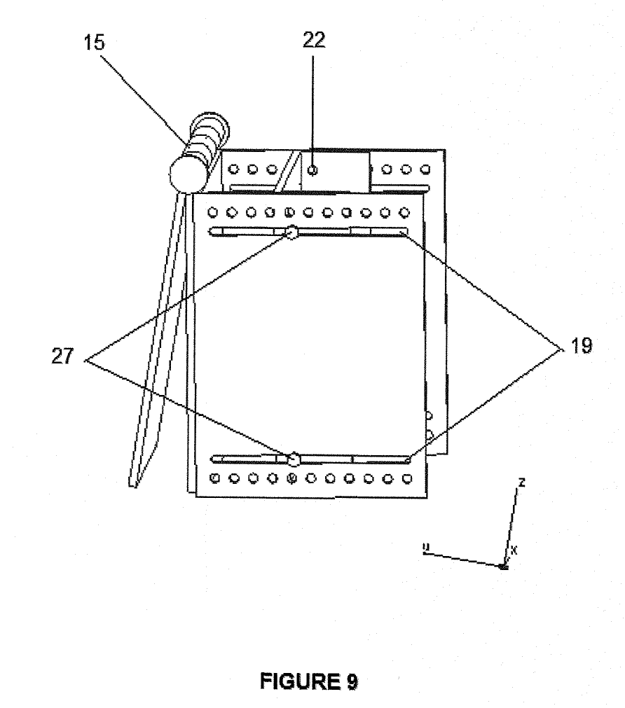

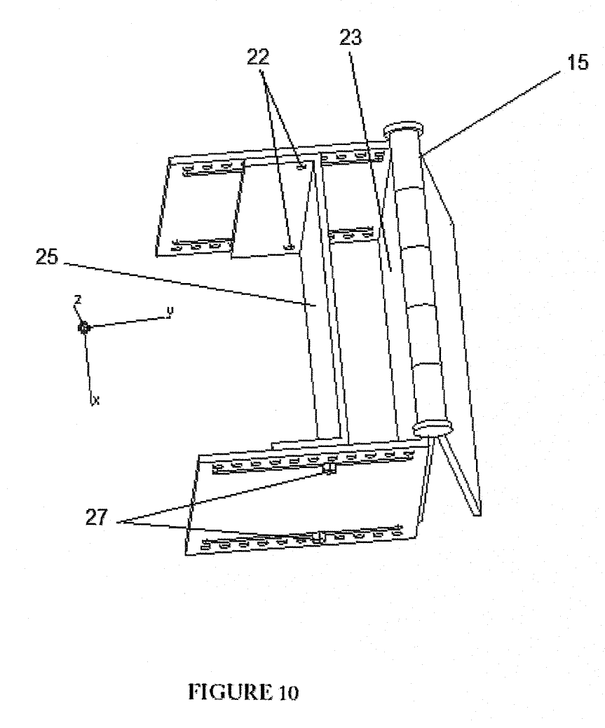

An actuator 16 is provided that is preferably situated on the boat. The actuator 16 preferably assists movement of the mounting plate 13 with respect to the support structure 14 when they are engaged (i.e. as shown in FIGS. 3, 4, and 8 to 10). The pivot plate 15 comprises two plates hinged along one side (at point 15 in FIGS. 1 to 4). One plate 17 of the pivot plate 15 attaches to the transom 11 of the boat 10, and the second plate 18 is what the support structure 14 is attached to.

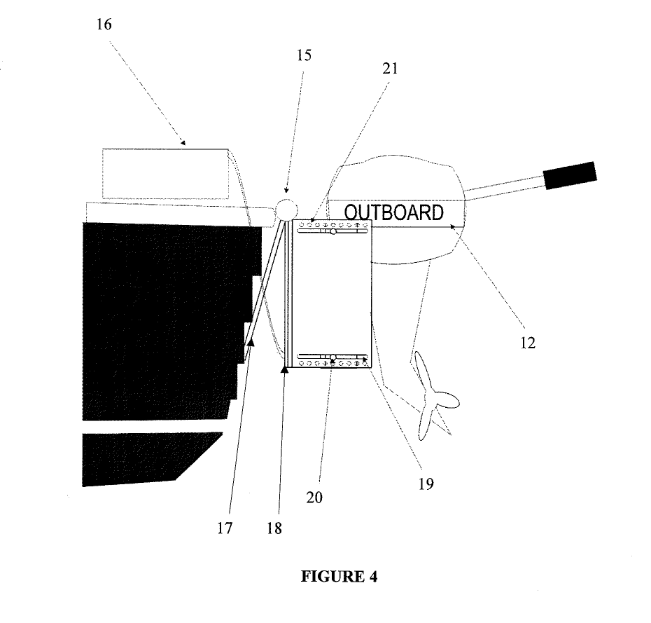

FIGS. 3 and 4 show the same views and parts as FIGS. 1 and 2, but with the components constructed. In FIG. 4, details of the support structure 14 when engaged with the mounting plate 13 can be seen. The support structure 14 has guides 19 cut out of it which receives extrusions 20 on the mounting plate 13 (which cannot be seen clearly because it is behind the support structure 14). This allows the mounting plate 13 to be slid towards, and further away from, the transom 11 of the boat 10. As the guides 19 in the support structure 14 are closed, the mounting plate 13 is can only be removed from the support structure 14 by removing the extrusions 20.

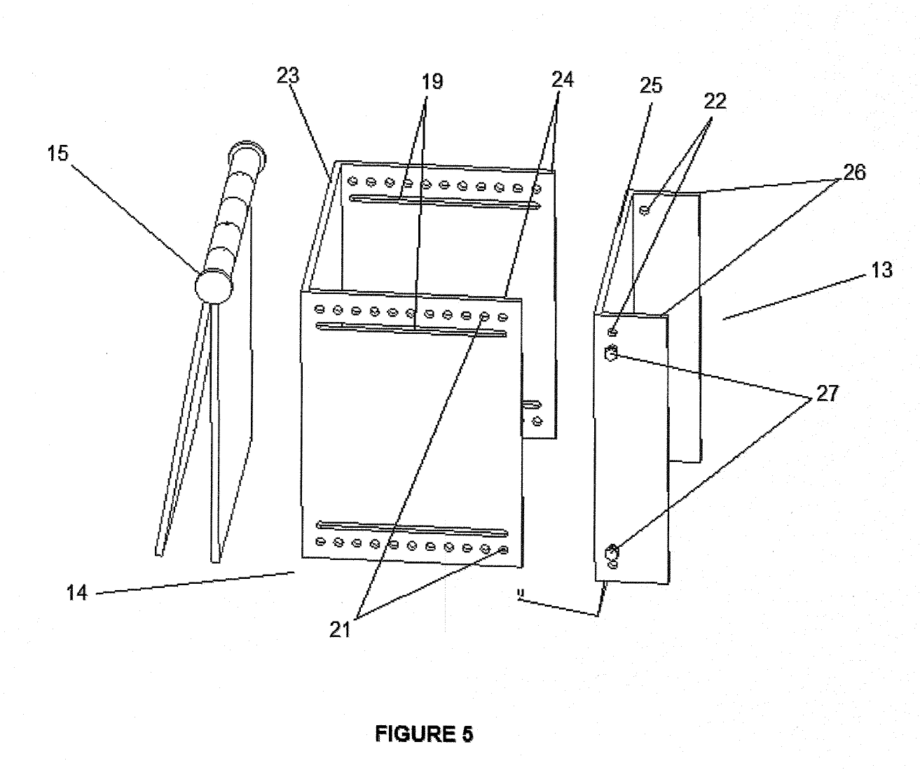

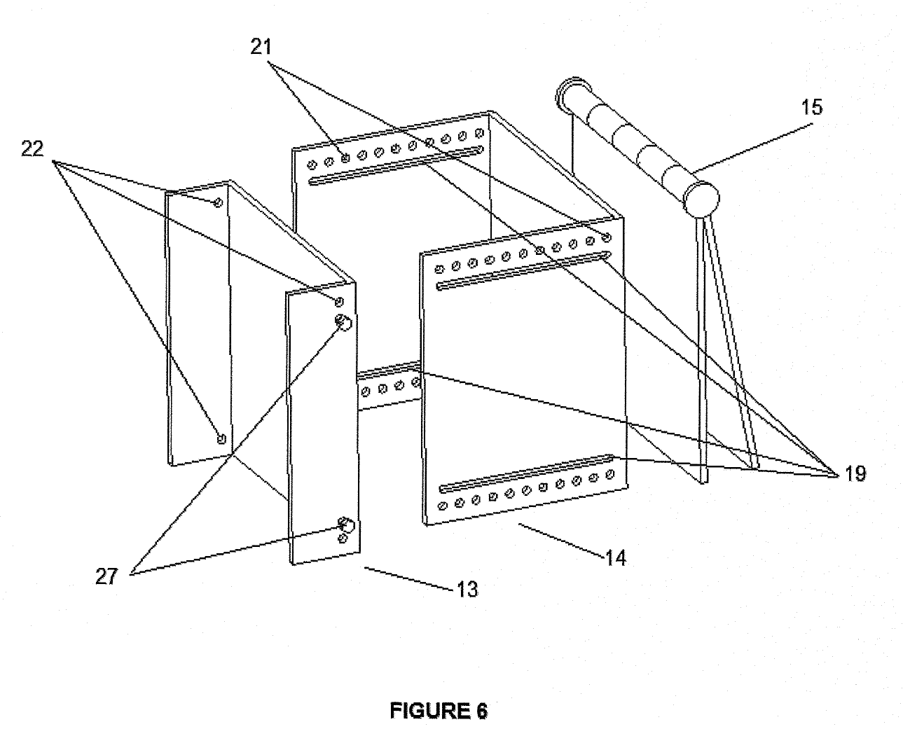

Locking holes 21 are provided in the support structure 14 (as shown) and the mounting plate 14 (at no. 22, shown best in FIGS. 5 and 6). When the holes 21 in the support structure 14 are lined up with the holes 22 in the mounting plate 13, a bolt can be placed through both sets of holes 21, 22 to lock the mounting plate 13, with the boat motor 12 thereon, at a desired distance from the transom 11 of the boat 10.

As the boat motor 12 is usually heavy, the actuator 16 can provide power to assist movement of the mounting plate 13 with respect to the support structure 14. Additionally, the actuator 16 may be able to provide power to assist movement of the two plates 17, 18. The actuator 16 preferably drives a hydraulic cylinder (not shown), but other movement means may also be used.

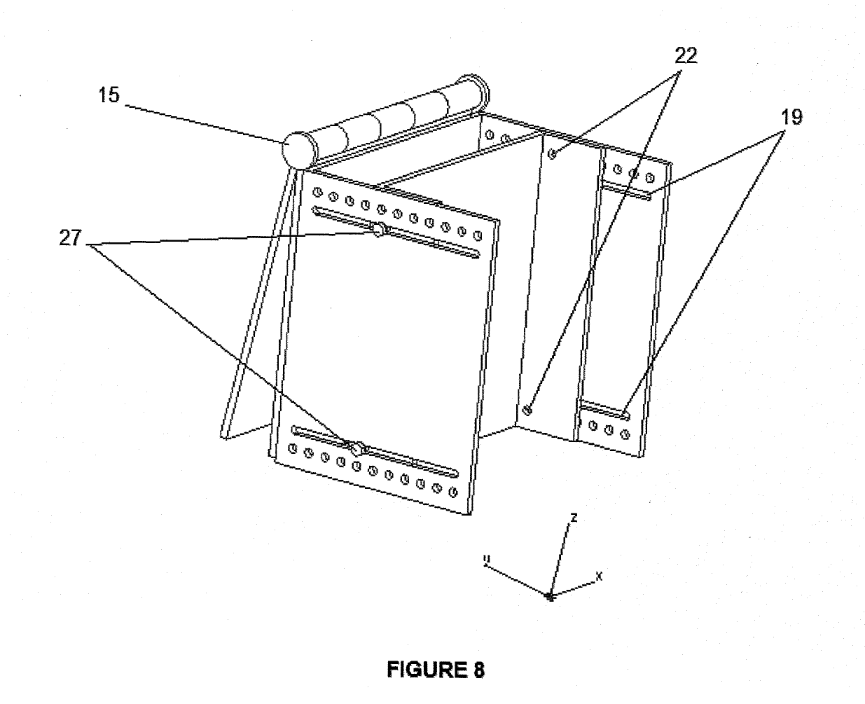

FIGS. 5 to 7 show the moveable boat motor mount parts in greater detail and FIGS. 8 to 10 show the moveable boat motor mount as a whole in greater detail. As can be seen from these perspective figures, the support structure 14 is a squared ‘U’ shape, having a rear wall 23 that is attached to plate 18 of the pivot plate 15. The support structure 14 has sides 24 that extend perpendicularly from the rear wall 23. The sides 24 each have two guides 19 and two rows of holes 21.

The mounting plate 13 is also a squared ‘U’ shape and has a rear wall 25 with perpendicularly extending sides 26. The distance between the two sides 26 of the mounting plate 13 is slightly less than the distance between the two sides 24 of the support structure 14 so that the mounting plate 13 can be received by the support structure 14. Each of the sides 26 have two holes 22 the same distance apart as the holes 21 on the support structure 14. Each side 26 also have two extrusions 20 that have enlarged heads 27.

When assembled the extrusions are received by the guides 19 in the support structure 14. Each of the four guides 19 (two on each side 24) receives one extrusion 20 from the mounting plate 13. The guides are preferably elongate and approximately the width of the extrusions 20. When assembled (as shown in FIGS. 8 to 10) this allows the mounting plate 13 to slide back and forth in the support structure 14. The enlarged heads 27 of the extrusions 20 prevent the extrusions 20 from sliding through the guides 19 in the support structure 14. As the mounting plate 13 slides in the support structure 14, the holes 22 on the mounting plate 13 move past the holes 21 on the support structure 14. The mounting plate 13 can be locked at a particular location by putting a bolt (not shown) through each set of matching holes.

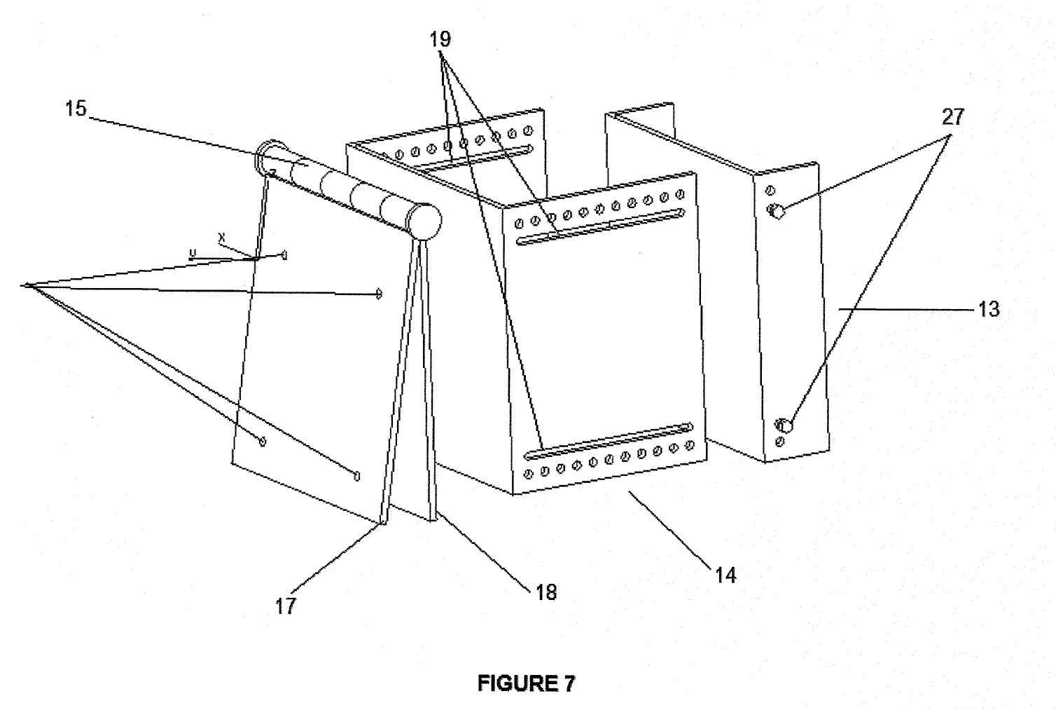

Plate 17 of the pivot plate 15 has holes 28 in it, as seen in FIG. 7, to enable it to easily be affixed to the transom 11 of the boat 10. In the preferred embodiment there are six holes, but any number and/or any suitable method may be used to attach the pivot plate 15 to the transom 11. Furthermore, is some embodiments the support structure 14 may be affixed directly onto the transom 11 of the boat 10. In this case the rear wall 23 of the support structure 14 may have holes and/or the affixing means to attach the maneuverable motor mount to the boat 10.

An advantage of the maneuverable motor mount is that the boat motor 12 can be set at desired distances from the transom 11 of the boat 10 allowing the motor placement to shift the centre of gravity and maximise boat performance in all water conditions.

For example, in calm waters to get maximum speed from a boat you need minimum surface are and minimum resistance against the water. To do this typically the boat is trimmed upwards allowing the angle of the boat against the water to create lift. The angle of the boat against the water also creates resistance against the water. By moving the motor further back, the centre of gravity is also moved back, making the nose of the boat lighter and easier to lift. If the nose is lighter or easier to lift, the boat can achieve the minimum surface area with less of an angle against the water and consequently with less resistance and better high speed performance.

In the majority of circumstances, boats are too long and heavy in the nose for the power of the motor. In these circumstances boats cannot achieve minimum surface area. To move the centre of gravity back in these boats will also achieve less surface area on the water.

In rough water, on the other hand, it is desirable to keep the nose of the boat down so the waves don't throw the boat nose in the air. For this reason, longer boats usually go better in rough water as the leverage of the length of the boat is equal to more weight at the nose. Other ways to make boats perform better in rough water is to place ballast in an appropriate positions in to boat.

Obviously, having the motor set far back, making the nose light, will be a disadvantage in rough conditions. An optimum setup is to have the motor against the transom, moving the centre of gravity forward, reducing the leverage and making the nose harder to be lifted by waves it may encounter.

Advantageously, the maneuverable motor mount gives the operator the opportunity to adjust the boat setup to suit all water conditions.

A further advantage of the maneuverable motor mount is that the water that rushes past the boat hull at the point where the bottom joins the boat transom is forced upwardly and a turbulence develops and extends rearward of the boat transom. This turbulence decreases with increasing distance from the boat transom. Accordingly, the performance of the boat motor 12 is generally enhanced by the maneuverable motor mount as the motor can be easily mounted away from the transom 11 of the boat 10 where the propeller of the motor can operate in quieter water beyond the cavitation created by the boat hull.

It is to be understood that the terminology employed above is for the purpose of description and should not be regarded as limiting. The foregoing embodiments are intended to be illustrative of the invention, without limiting the scope thereof. The invention is capable of being practised with various modifications and additions as will readily occur to those skilled in the art. Although the invention has been described with respect to a boat motor and a transom, no limitation is meant thereby.

Throughout this specification, including the claims, where the context permits, the term “comprise” and variants thereof such as “comprises” or “comprising” are to be interpreted as including the stated integer or integers without necessarily excluding any other integers.

1. A maneuverable motor mount for a boat motor comprising:
a least one support structure having a portion extending substantially perpendicular to the transom of a boat;
a mounting plate that is substantially perpendicular to the support structure wherein the boat motor is bolted on to the mounting plate; and
a movement means to move a portion of the mounting plate along the support structure.

2. A method of moving a boat motor with respect to a boat transom comprising the steps of:
ensuring a mounting plate is unlocked with respect to at least one support structure having at least a portion extending perpendicular to the boat transom;
moving the mounting plate along the perpendicular extensions of the support structure with a movement means to a desired location;
and securing the mounting plate at the desired location on the perpendicular extension of the support structure.

3. A maneuverable motor mount for a boat motor comprising a mounting plate adapted to attach a boat motor; a support structure attached to a rear portion of the boat and mounting the mounting plate; and a movement means to move at least a portion of the mounting plate relative to the support structure to adjust the separation distance of the boat motor from the rear of the boat.
